(19) United States
(12) Patent Application Publication
(10) Pub. No.: US 2003/0047431 A1
(43) Pub. Date: Mar. 13, 2003

(54) Multidirectional operation key

(76) Inventors: Shih-Chieh Wang, Taipei (TW); Chien-Lung Huang, Taipei (TW); Yen-Te Chiang, Taipei (TW); James Tseng, Shulin City (TW); Chu-Yang Hsu, Hsinchu (TW); Hsi-Hsing Hsu, Taoyuan (TW)

Correspondence Address: RABIN & CHAMPAGNE, PC, 1101 14TH STREET, NW, SUITE 500, WASHINGTON, DC, 20005, US

(21) Appl. No.: 10/235,832

(22) Filed: Sep. 6, 2002

(30) Foreign Application Priority Data
Sep. 7, 2001 (TW) 090215461

(51) Int. Cl. H01H 25/04

(52) U.S. Cl. 200/6 A

(57) ABSTRACT

A multidirectional operation key including a micro stick switch and a flexible navigation button is provided. The multidirectional operation key, which absorbs the manufacturing and assembly tolerances, is installed in a small-sized electronic device which has an upper cover. The flexible navigation button is used to fine-tune the relative position between the multidirectional operation key and the upper cover such that the multidirectional operation key can perfectly fit into an opening on the upper cover. Of which, the flexible navigation button is a two pieces design including a body and a shaft cover. The upper end of the shaft cover is flexibly jointed with the body while the lower end of the shaft cover is tightly mounted on the micro stick switch with the body being held up by an elastic piece situated between the body and the shaft cover. Besides, the multidirectional operation key further includes an elastic holding piece which holds and keeps the flexible navigation button at a horizontal position.

This application incorporates by reference Taiwan application Serial No. 90215461, Filed Sep. 7, 2001.

### BACKGROUND OF THE INVENTION

1. Field of the Invention

The invention relates in general to the design of a key, and more particularly to a multidirectional operation key.

2. Description of the Related Art

As the rapid advance in hi-tech industries, new technologies and new products are constantly invented and announced. In recent years, the portable products have been equipped with more and more functions providing the users with more flexibilities to deal with their daily business or personal affairs without being subject to the restraint of time and space. The users can access and store the data in an instant and bring the data away with them. Take the personal digital assistant (PDA) for example. Due to its compact and portable features as well as its simple user's interface, the PDA has gained a great popularity of both commercial and individual consumers. To fit human consideration better and to provide an even more convenient portability, the exterior of the portable products is getting lighter, thinner, shorter and smaller. Not only must the parts inside be designed with great precision, the external mechanism must be delicate and attractive as well.

The multidirectional micro stick switch is a space saving design. It operates in multi-directions. The four directions of a four-directional micro stick switch are the front, rear, left and right, while a five-directional micro stick switch has an additional downward action key. Due to its space saving design, the micro stick switch has been widely used in small-sized electronic devices such as the PDA, the digital cameral or the mobile phone.

Please refer to FIG. 1, which is a three-dimensional diagram of a multidirectional operation key used in a small-sized electronic device. As illustrated in FIG. 1, a PDA is used as an example of a small-sized electronic device 100. Its upper cover 120 has an opening 122 into which a multidirectional operation key 110 is inserted.

Please refer to FIG. 2, which is a structural sectional view of a conventional multidirectional operation key. The multidirectional key includes a navigation button 210 and a micro stick switch 230. The micro stick switch 230 is welded onto a printed circuit board (PCB) 232, while the navigation button 210 is mounted on a micro stick switch 230. As shown in FIG. 2, an apparent and unsightly gap exists between the navigation button 210 of a conventional multidirectional operation key and an upper cover 220 of a small-sized electronic device. Furthermore, the gaps exist in the two sides are normally uneven, say, d1 is far larger than d2, due to the manufacturing tolerances of the parts themselves during manufacturing accompanied by the assembly tolerances which occurred during assembly because of the existence of location biases between the parts. The uneven gaps debase the quality and the value of a small-sized electronic device which requests a delicate and attractive exterior.

Generally speaking, tolerance is measured in terms of bars. Each bar measures 0.01 mm in width. The upper cover 220, the navigation button 210 and the micro stick switch 230 are separate assembly elements with 5 bars of manufacturing tolerance themselves; still, ten more bars of assembly tolerance will occur after assembly. For example, when the micro stick switch 230 is welded onto the PCB 232 ten more bars of tolerance will occur due to the position of the positioning hole and the specification of the micro stick switch 230. Thus when a gap of 0.2 mm exists, ten bars of tolerance will result in totally twenty bars of tolerance in the two sides. Such bias is not only apparent, but also unsightly. Normally a visual distortion method is used to resolve the problem of having uneven gaps in the two sides by enlarging the gap between the navigation button 210 and the upper cover 220. For example, when the gap between the key and the upper cover remains 1 mm in distance, the ten more bars of tolerance generated will become less apparent. However, such gap-enlarging method only makes the gaps between parts even more apparent revealing the truth that the product is lack of delicacy.

Besides, the design of the navigation button 210 is directly related to user's convenience of operation and tactile impression when the user would like to indirectly control the micro stick switch 230 underneath by pressing the navigation button 210 atop. As shown in FIG. 2, conventionally, the navigation button 210 is a single piece design directly mounted on the micro stick switch 230 which always tilts or ends up with a seized key when manufacturing tolerance occurs. Moreover, a smooth operation of the key is always lacking because the micro stick switch is inflexible in transmitting the force applied on it.

### SUMMARY OF THE INVENTION

It is therefore an object of the invention to provide a multidirectional operation key, which, by absorbing both manufacturing and assembly tolerances, eliminates the gap between the multidirectional operation key and the upper cover, giving the mechanism a more delicate and attractive exterior.

According to the object of the invention, a multidirectional operation key installed on a small-sized electronic device equipped with an upper cover is provided. The multidirectional operation key includes a micro stick switch and a flexible navigation button; wherein the micro stick switch is installed on a printed circuit board inside the small-sized electronic device, whereas the navigation button is used to fine-tune the relative position between the multidirectional operation key and the upper cover such that the multidirectional operation key can perfectly fit into the opening on the upper cover. Of which, the flexible navigation button further includes a body, a shaft cover and an elastic piece. The upper end of the shaft cover is flexibly jointed with the downward extension of the body, while the lower end of the shaft cover is tightly mounted on the micro stick switch with the body being held against by the elastic piece installed between the body and the shaft cover such that a tight contact between the body and the upper cover can be attained. Apart from that, the multidirectional operation key further includes an elastic holding piece, being installed at the outer edge of the inner wall of the body, holds and keeps the flexible navigation button at a horizontal position.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates a three dimensional diagram of a multidirectional operation key installed in a personal digital assistant;

FIG. 2 shows a sectional structural view of a conventional multidirectional operation key; and

FIG. 3 shows a sectional structural view of a multidirectional operation key according to a preferred embodiment of the invention.

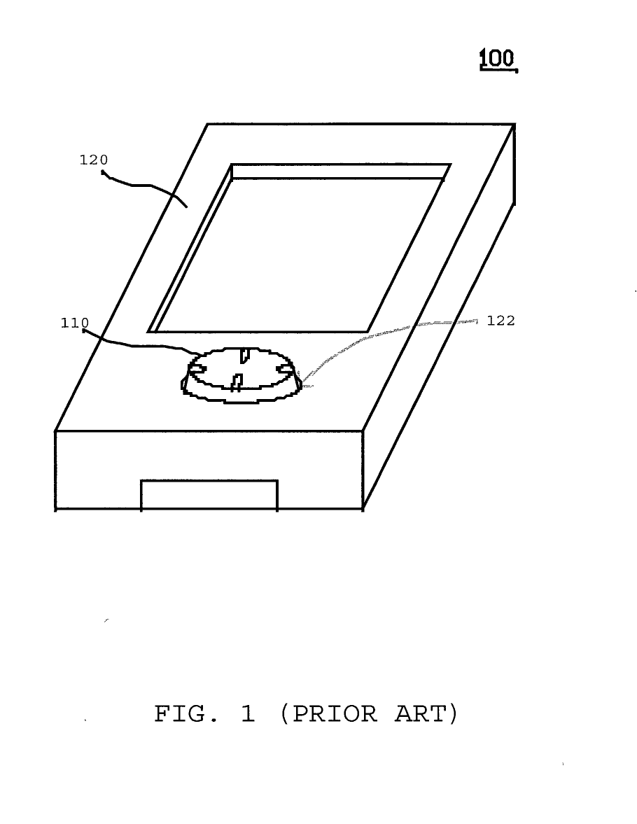

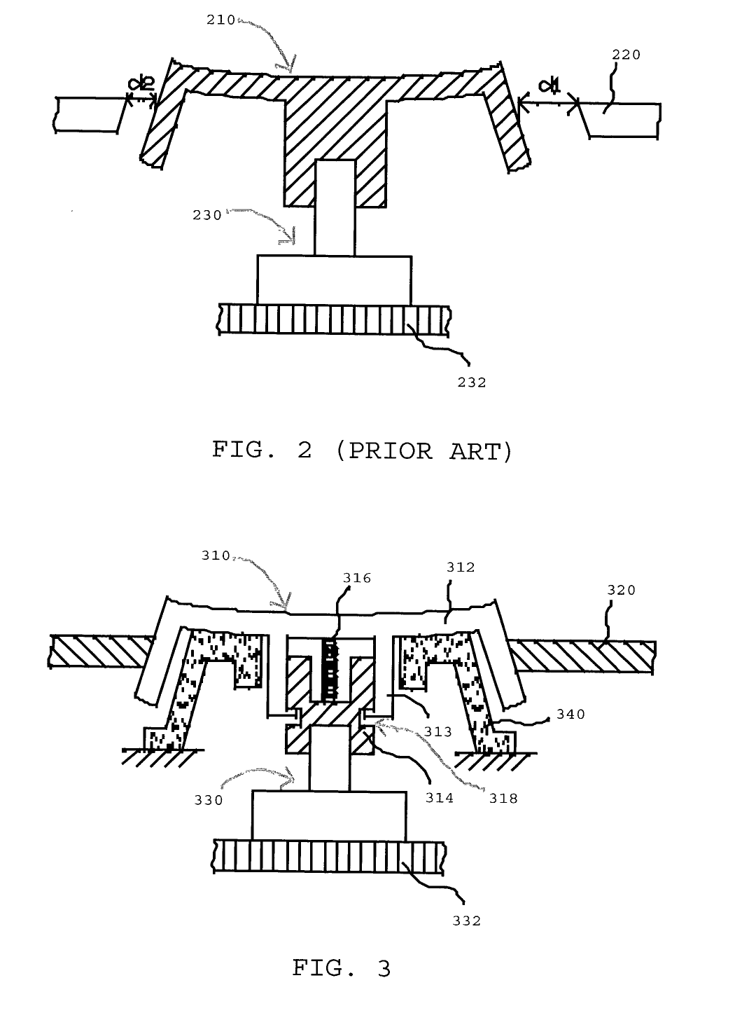

### DESCRIPTION OF THE PREFERRED EMBODIMENT

Please refer to FIG. 3, a sectional structural view of a multidirectional operation key according to a preferred embodiment of the invention is illustrated. As shown in FIG. 3, a multidirectional operation key is installed on the upper cover of a small-sized electronic device. It is preferred but not limited that the small-sized electronic device be a personal digital assistant, a digital camera or a mobile phone. The invention can be used in any small-sized electronic device equipped with an upper cover and an operation-control key. The multidirectional operation key includes a micro stick switch 330 and a flexible navigation button 310, wherein the micro stick switch 330 is welded onto the printed circuit board (PCB) 332 which is situated inside a small-sized electronic device, while the flexible navigation button 310 has a tight contact with the upper cover 320 of the small-sized electronic device. Of which, the flexible navigation button 310 is used to fine-tune the relative position between the multidirectional operation key and the upper cover 320 such that the multidirectional operation key can perfectly fit into the opening on the upper cover. The flexible navigation button 310 according to the invention is a two pieces device including a body 312 and a shaft cover 314 whose structure can be a cylinder or a conic cylinder with a wider top or a wider bottom. The top end of the shaft cover 314 is flexibly jointed to the downward extension 313, while the lower end of the shaft cover 314 is tightly mounted on the micro stick switch 330. In addition to that, an elastic piece 316 is installed between the body 312 and the shaft cover 314. With the body 312 being held against by the elastic piece 316, a tight contact between the body 312 and the upper cover 320 is achieved. As illustrated in FIG. 3, the top face of the shaft cover 314 contacts the elastic piece 316, wherein the elastic piece can be a spring while the face of the shaft cover 314 can be concave, flat or convex with a protrusion to hold the spring. Both the manufacturing tolerance and the assembly tolerance exist between the body of the flexible navigation button 312, the upper cover 320 and the micro stick switch 330. Using the two pieces design of the flexible navigation button 310 to absorb the tolerances which would otherwise be seen in the exterior assures a tight contact between the flexible navigation button and the upper cover bringing about a more delicate and attractive exterior to the mechanism.

As shown in FIG. 3, the multidirectional operation key further includes an elastic holding piece 340. The lower end of the elastic holding piece is fixed onto other elements inside the small-sized electronic device while the upper end of the elastic piece contacts the body 312 of the flexible navigation button 310. Since the elastic holding piece 340 is disposed under the inner wall inside the body 312, the flexible navigation button 310 can be held and kept at a horizontal position avoiding a seized key caused by the tilting of the flexible navigation button 310. The elastic holding piece 340 can preferably be made of rubber with good elasticity. Besides, the elastic holding piece 340 can be made of different materials according to different requirements of holding strength such that a better tactile sensation can be provided. The shaft cover can preferably be made of plastics and be flexibly jointed with the body 312 via a lock mechanism 318. For example, the lock mechanism 318 as shown in FIG. 3 is a wedge lock which joins together using a retaining hook and a retaining hook groove. However, the lock mechanism 318 is not limited to the buckle-and-trip design; it can be an elastic joint mechanism or any other mechanism with a flexible lock-joint.

The multidirectional operation key disclosed according to a preferred embodiment of the invention has the following features and advantages:

1. The two pieces design of a flexible navigation button. This design absorbs manufacturing tolerance as well as assembly tolerance. A tight contact between the flexible navigation button and the upper cover can still be attained despite there exist ten more manufacturing and assembly tolerances. The tolerances that would otherwise appear in the exterior are absorbed by inner structures resolving the problem of having a less-attractive exterior.

2. The design of having an elastic holding piece. The elastic holding piece is used to sustain the flexible navigation button upwardly such that the flexible navigation button can be held and kept at a horizontal position avoiding a seized key caused by the tilting of the flexible navigation button. The elastic holding piece 340 can be made of different materials according to different requirements of holding strength such that its touching sensitivity can be improved and a better tactile sensation and a convenient operation be provided.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multidirectional operation key, which is installed in a small-sized electronic device equipped with an upper cover, wherein the multidirectional operation key comprises:
a micro stick switch which is installed on a printed circuit board, wherein the printed circuit board is situated inside the small-sized electronic device; and
a flexible navigation button used to fine-tune the relative position between the multidirectional operation key and the upper cover such that the multidirectional operation key can perfectly fit into the opening on the upper cover, wherein the flexible navigation button comprises:
a body with a downward extension;
a shaft cover with its upper end being flexibly jointed with the downward extension and its lower end tightly mounted on the micro stick switch; and
an elastic piece, situated between the body and the shaft cover, facilitating a tight contact between the body and the upper cover by sustaining the body upwardly.

2. The multidirectional operation key according to claim 1 further comprising an elastic holding piece, being disposed under the inner wall of the body, for holding and keeping the flexible navigation button at a horizontal position.

3. The multidirectional operation key according to claim 2, wherein elastic holding piece is made of plastics.

4. The multidirectional operation key according to claim 1, wherein the shaft cover is flexibly jointed with the downward extension via a lock mechanism.

5. The multidirectional operation key according to claim 4, wherein the lock mechanism is a wedge lock.

6. The multidirectional operation key according to claim 1, wherein the micro stick switch is welded onto the printed circuit board.

7. The multidirectional operation key according to claim 1, wherein the small-sized electronic device is a personal digital assistant (PDA).

8. The multidirectional operation key according to claim 1, wherein the small-sized electronic device is a digital camera.

9. The multidirectional operation key according to claim 1, wherein the small-sized electronic device is a mobile phone.

10. A flexible navigation button used in a multidirectional operation key to fine-tune the relative position between the multidirectional operation key and the upper cover such that the multidirectional operation key can perfectly fit into an opening on the upper cover, wherein the flexible navigation button further comprises:
a body with a downward extension;
a shaft cover with its upper end being flexibly jointed with the downward extension and its lower end tightly mounted on the micro stick switch; and
an elastic piece, being situated between the body and the shaft cover, facilitates a tight contact between the body and the upper cover by sustaining the body upwardly.

11. The flexible navigation button according to claim 10, wherein the multidirectional operation key further comprises an elastic holding piece, being disposed under the inner wall of the body, for holding and keeping the flexible navigation button at a horizontal position.

12. The flexible navigation button according to claim 11, wherein the elastic holding piece is made of rubber.

13. The flexible navigation button according to claim 10, wherein the shaft cover is flexibly jointed with the body via a lock mechanism.

14. The flexible navigation button according to claim 13, wherein the lock mechanism is a wedge lock.

15. The flexible navigation button according to claim 10, wherein the micro stick switch is welded onto the printed circuit board.

16. The flexible navigation button according to claim 10, wherein the small-sized electronic device is a personal digital assistant (PDA).

17. The flexible navigation button according to claim 10, wherein the small-sized electronic device is a digital camera.

18. The multidirectional operation key according to claim 10, wherein the small-sized electronic device is a mobile phone.
